(19) United States
(12) Patent Application Publication
(10) Pub. No.: US 2026/0087093 A1
(43) Pub. Date: Mar. 26, 2026

(54) Rate Control for Matrix Accelerator Hardware

(71) Applicant: Apple Inc., Cupertino, CA (US)

(72) Inventors: Angel E. Socarras, Orlando, FL (US); Anurag Choudhury, Austin, TX (US); Arvind Arunasalam, Austin, TX (US); Benoit M. Jubelin, Austin, TX (US); David K. Li, Austin, TX (US); Evan R. Lissoos, Austin, TX (US)

(21) Appl. No.: 19/015,074

(22) Filed: Jan. 9, 2025

Related U.S. Application Data
(60) Provisional application No. 63/699,217, filed on Sep. 26, 2024.

(51) Int. Cl. G06F 17/16

(52) U.S. Cl. CPC G06F 17/16

(57) ABSTRACT

Techniques are disclosed relating to hardware acceleration for matrix operations. In some embodiments, processor circuitry configured to execute a first matrix multiply instruction and a second matrix multiply instruction included in an execution thread. Control circuitry generates a first set of operations, including multiple dot product and multiple accumulate operations, for the first matrix multiply instruction and a second set of operations, including multiple dot product and multiple accumulate operations, for the second matrix multiply instruction. The control circuitry specifies a first execution rate for the first set of operations and a second, different execution rate for the second set of operations. Matrix acceleration circuitry performs the sets of operations at the specified rates. The rates may be based on thermal measurements.

The present application claims priority to U.S. Provisional App. No. 63/699,217, entitled “Rate Control for Matrix Accelerator Hardware,” filed Sep. 26, 2024, the disclosure of which is incorporated by reference herein in its entirety.

### BACKGROUND

### Technical Field

This disclosure relates generally to computer processors and more particularly to accelerator hardware for matrix operations.

### Description of Related Art

Some computing systems include acceleration hardware (which may be implemented as co-processor hardware) for certain types of operations. For example, matrix acceleration hardware may be specially configured to perform matrix operations such as matrix multiplication. Accelerator hardware may provide better performance than software implementations running on traditional processors. Accelerator hardware, however, may have substantial impacts on power consumption and temperature, which may also vary widely across different system workloads.

### BRIEF DESCRIPTION OF DRAWINGS

FIG. 1A is a diagram illustrating an overview of example graphics processing operations, according to some embodiments.

FIG. 1B is a block diagram illustrating an example graphics unit, according to some embodiments.

FIG. 2 is a block diagram illustrating fine-grained rate control for matrix multiply accelerator circuitry, according to some embodiments

FIG. 3 is a block diagram illustrating example thermal-based rate control and rate-based completion tracking, according to some embodiments.

FIG. 4 is a block diagram illustrating example power gating of accelerator hardware, according to some embodiments.

FIG. 5 is a pipeline state diagram for different example accelerator rates according to one de-rate implementation, according to some embodiments.

FIG. 6 is a pipeline state diagram for different example accelerator rates according to another de-rate implementation, according to some embodiments.

FIG. 7 is a flow diagram illustrating an example method, according to some embodiments.

FIG. 8 is a block diagram illustrating an example computing device, according to some embodiments.

FIG. 9 is a diagram illustrating example applications of disclosed systems and devices, according to some embodiments.

FIG. 10 is a block diagram illustrating an example computer-readable medium that stores circuit design information, according to some embodiments.

### DETAILED DESCRIPTION

Traditional power management techniques may not provide fine-grained control of power or thermal parameters for acceleration hardware, e.g., for matrix operations. Note that a processor may execute instruction set architecture (ISA) instructions for accelerated operations, e.g., matrix multiply instructions. These instructions may be broken down into a set of multiple operations (e.g., multiple dot-product-accumulate operations for matrix multiplications) by either the processor or the accelerator hardware. In disclosed embodiments, power control circuitry controls the execution rate of matrix acceleration hardware, e.g., on a per-ISA-instruction basis. For example, a shader processor of a graphics processing unit (GPU) may consecutively execute matrix multiply instruction A and matrix multiply instruction B. In this scenario, control circuitry may control the matrix accelerator hardware to execute the set of micro-operations for instruction A at a different rate than the set of micro-operations for instruction B.

In some embodiments, the rate control is based on thermal data, e.g., to control the temperature of a system on a chip (SoC). The rate control may use a proportional-integral (PI) controller, for example. Note that temperatures over certain thresholds may cause errors in computing, equipment damage, or both. Fine-grained temperature-based control may allow a system to reduce or avoid these issues, with reduced performance impacts relative to less granular control techniques. Also, specifically targeting the matrix accelerator hardware for rate control may be particularly helpful for matrix-heavy workloads where it may be desirable to keep other components (e.g., a memory controller) running at full rate.

Control circuitry may track the rate to know when results are ready to read. Power control circuitry may also gate accelerator hardware in certain de-rate situations.

Therefore, in various embodiments, disclosed techniques may advantageously provide fine-grained power and thermal control in the context of matrix acceleration hardware, which may mitigate power or temperature concerns with limited performance impacts.

### Graphics Processing Overview

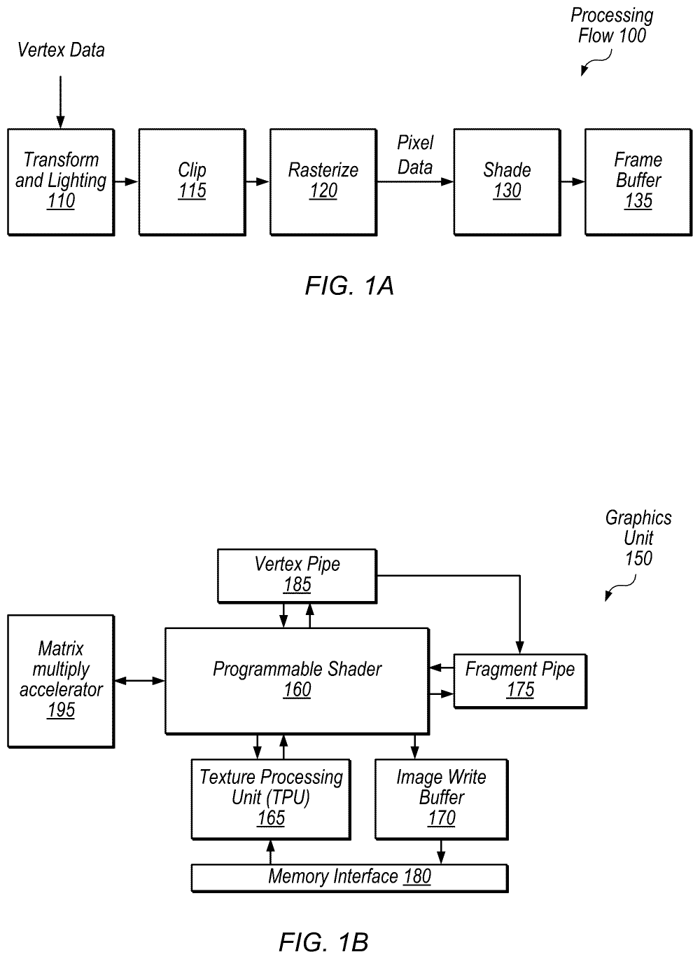

Referring to FIG. 1A, a flow diagram illustrating an example processing flow 100 for processing graphics data is shown. In some embodiments, transform and lighting procedure 110 may involve processing lighting information for vertices received from an application based on defined light source locations, reflectance, etc., assembling the vertices into polygons (e.g., triangles), and transforming the polygons to the correct size and orientation based on position in a three-dimensional space. Clip procedure 115 may involve discarding polygons or vertices that fall outside of a viewable area. In some embodiments, geometry processing may utilize object shaders and mesh shaders for flexibility and efficient processing prior to rasterization. Rasterize procedure 120 may involve defining fragments within each polygon and assigning initial color values for each fragment, e.g., based on texture coordinates of the vertices of the polygon. Fragments may specify attributes for pixels which they overlap, but the actual pixel attributes may be determined based on combining multiple fragments (e.g., in a frame buffer), ignoring one or more fragments (e.g., if they are covered by other objects), or both. Shade procedure 130 may involve altering pixel components based on lighting, shadows, bump mapping, translucency, etc. Shaded pixels may be assembled in a frame buffer 135. Modern GPUs typically include programmable shaders that allow customization of shading and other processing procedures by application developers. Thus, in various embodiments, the example elements of FIG. 1A may be performed in various orders, performed in parallel, or omitted. Additional processing procedures may also be implemented.

Referring now to FIG. 1B, a simplified block diagram illustrating a graphics unit 150 is shown, according to some embodiments. In the illustrated embodiment, graphics unit 150 includes programmable shader 160, vertex pipe 185, fragment pipe 175, texture processing unit (TPU) 165, image write buffer 170, and memory interface 180. In some embodiments, graphics unit 150 is configured to process both vertex and fragment data using programmable shader 160, which may be configured to process graphics data in parallel using multiple execution pipelines or instances.

Vertex pipe 185, in the illustrated embodiment, may include various fixed-function hardware configured to process vertex data. Vertex pipe 185 may be configured to communicate with programmable shader 160 in order to coordinate vertex processing. In the illustrated embodiment, vertex pipe 185 is configured to send processed data to fragment pipe 175 or programmable shader 160 for further processing.

Fragment pipe 175, in the illustrated embodiment, may include various fixed-function hardware configured to process pixel data. Fragment pipe 175 may be configured to communicate with programmable shader 160 in order to coordinate fragment processing. Fragment pipe 175 may be configured to perform rasterization on polygons from vertex pipe 185 or programmable shader 160 to generate fragment data. Vertex pipe 185 and fragment pipe 175 may be coupled to memory interface 180 (coupling not shown) in order to access graphics data.

Programmable shader 160, in the illustrated embodiment, is configured to receive vertex data from vertex pipe 185 and fragment data from fragment pipe 175 and TPU 165. Programmable shader 160 may be configured to perform vertex processing tasks on vertex data which may include various transformations and adjustments of vertex data. Programmable shader 160, in the illustrated embodiment, is also configured to perform fragment processing tasks on pixel data such as texturing and shading, for example. Programmable shader 160 may include multiple sets of multiple execution pipelines for processing data in parallel.

In some embodiments, programmable shader includes pipelines configured to execute one or more different SIMD groups in parallel. Each pipeline may include various stages configured to perform operations in a given clock cycle, such as fetch, decode, issue, execute, etc. The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

The term “SIMD group” is intended to be interpreted according to its well-understood meaning, which includes a set of threads for which processing hardware processes the same instruction in parallel using different input data for the different threads. SIMD groups may also be referred to as SIMT (single-instruction, multiple-thread) groups, single instruction parallel thread (SIPT), or lane-stacked threads. Various types of computer processors may include sets of pipelines configured to execute SIMD instructions. For example, graphics processors often include programmable shader cores that are configured to execute instructions for a set of related threads in a SIMD fashion. Other examples of names that may be used for a SIMD group include: a wavefront, a clique, or a warp. A SIMD group may be a part of a larger threadgroup of threads that execute the same program, which may be broken up into a number of SIMD groups (within which threads may execute in lockstep) based on the parallel processing capabilities of a computer. In some embodiments, each thread is assigned to a hardware pipeline (which may be referred to as a “lane”) that fetches operands for that thread and performs the specified operations in parallel with other pipelines for the set of threads. Note that processors may have a large number of pipelines such that multiple separate SIMD groups may also execute in parallel. In some embodiments, each thread has private operand storage, e.g., in a register file. Thus, a read of a particular register from the register file may provide the version of the register for each thread in a SIMD group.

As used herein, the term “thread” includes its well-understood meaning in the art and refers to sequence of program instructions that can be scheduled for execution independently of other threads. Multiple threads may be included in a SIMD group to execute in lock-step. Multiple threads may be included in a task or process (which may correspond to a computer program). Threads of a given task may or may not share resources such as registers and memory. Thus, context switches may or may not be performed when switching between threads of the same task.

In some embodiments, multiple programmable shader units 160 are included in a GPU. In these embodiments, global control circuitry may assign work to the different sub-portions of the GPU which may in turn assign work to shader cores to be processed by shader pipelines.

TPU 165, in the illustrated embodiment, is configured to schedule fragment processing tasks from programmable shader 160. In some embodiments, TPU 165 is configured to pre-fetch texture data and assign initial colors to fragments for further processing by programmable shader 160 (e.g., via memory interface 180). TPU 165 may be configured to provide fragment components in normalized integer formats or floating-point formats, for example. In some embodiments, TPU 165 is configured to provide fragments in groups of four (a “fragment quad”) in a 2×2 format to be processed by a group of four execution pipelines in programmable shader 160.

Image write buffer 170, in some embodiments, is configured to store processed tiles of an image and may perform operations to a rendered image before it is transferred for display or to memory for storage. In some embodiments, graphics unit 150 is configured to perform tile-based deferred rendering (TBDR). In tile-based rendering, different portions of the screen space (e.g., squares or rectangles of pixels) may be processed separately. Memory interface 180 may facilitate communications with one or more of various memory hierarchies in various embodiments.

As discussed above, graphics processors typically include specialized circuitry configured to perform certain graphics processing operations requested by a computing system. This may include fixed-function vertex processing circuitry, pixel processing circuitry, or texture sampling circuitry, for example. Graphics processors may also execute non-graphics compute tasks that may use GPU shader cores but may not use fixed-function graphics hardware. As one example, machine learning workloads (which may include inference, training, or both) are often assigned to GPUs because of their parallel processing capabilities. Thus, compute kernels executed by the GPU may include program instructions that specify machine learning tasks such as implementing neural network layers or other aspects of machine learning models to be executed by GPU shaders. In some scenarios, non-graphics workloads may also utilize specialized graphics circuitry, e.g., for a different purpose than originally intended.

Further, various circuitry and techniques discussed herein with reference to graphics processors may be implemented in other types of processors in other embodiments. Other types of processors may include general-purpose processors such as CPUs or machine learning or artificial intelligence accelerators with specialized parallel processing capabilities. These other types of processors may not be configured to execute graphics instructions or perform graphics operations. For example, other types of processors may not include fixed-function hardware that is included in typical GPUs. Machine learning accelerators may include specialized hardware for certain operations such as implementing neural network layers or other aspects of machine learning models. Speaking generally, there may be design tradeoffs between the memory requirements, computation capabilities, power consumption, and programmability of machine learning accelerators. Therefore, different implementations may focus on different performance goals. Developers may select from among multiple potential hardware targets for a given machine learning application, e.g., from among generic processors, GPUs, and different specialized machine learning accelerators.

In the illustrated example, graphics unit 150 includes matrix multiply accelerator 195, which may include hardware configured to perform various matrix multiply operations in response to instruction(s) executed by programmable shader 160, as described in detail below.

### Overview of Fine-Grained Rate Control for Matrix Accelerator

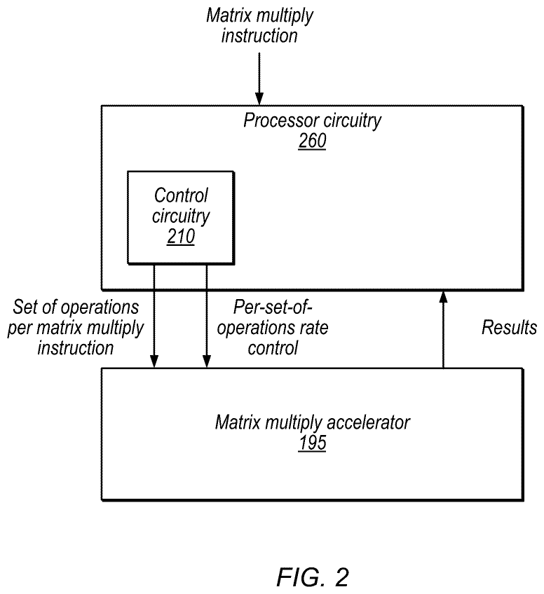

FIG. 2 is a block diagram illustrating fine grained rate control for matrix multiply accelerator circuitry, according to some embodiments. In the illustrated example, a system (e.g., a system on a chip or a computing device) includes matrix multiply accelerator 195 and processor circuitry 260.

Processor circuitry 260, in some embodiments, is configured to execute instructions of various programs. Programmable shader 160 is one example of processor circuitry 260; therefore processor circuitry 260 may execute graphics shader programs. In the illustrated example, processor circuitry 260 executes a matrix multiply instruction. This may be an instruction defined by an ISA of the processor circuitry and may be generated by a compiler, for example. The matrix multiply instruction may specify locations of two input matrices to be multiplied and the location of a result matrix. In the illustrated example, processor circuitry includes control circuitry 210, (although control circuitry 210 may be located elsewhere in other implementations, e.g., in accelerator 195).

Control circuitry 210, in some embodiments, is configured to generate a set of multiple operations based on the matrix multiply instruction and generate rate control signaling for the set of multiple operations. For example, the set of operations may be a set of dot-product-accumulate operations that each specify two dot product inputs and an accumulate input (although in other embodiments the set of operations may include multiple dot product and multiple accumulate operations, instead of combined dot-product-accumulate operations). The number of operations may correspond to the size of the matrices being operated on. Operations of the set of operations may be provided to accelerator arithmetic logic unit (ALU) circuitry over multiple clock cycles.

Matrix multiply accelerator 195, in some embodiments, includes specialized pipeline circuitry configured to execute the set of operations. For example, accelerator 195 may include multipliers and adders, which may be arranged to perform parts of matrix operations in parallel. Matrix multiply accelerator 195 provides results to processor circuitry 260, e.g., via a memory space accessible to both (for which a data cache may store various operand data). Accelerator 195 may also implement internal caching of input operands, intermediate results, and final results, or some combination thereof.

In embodiments with multiple accelerators 195, each accelerator 195 may be configured to perform a matrix operation (e.g., a multiply) of a given size and provide results back to the requesting processor. Therefore, different accelerators may execute ISA instructions in parallel, potentially at different rates.

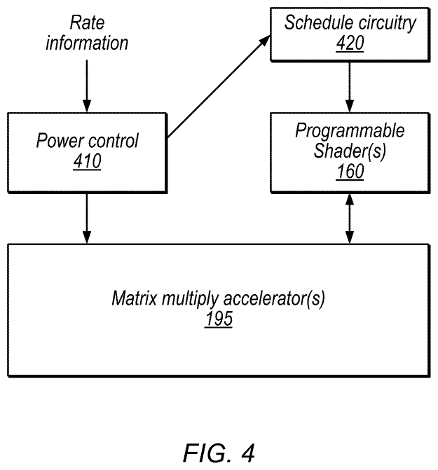

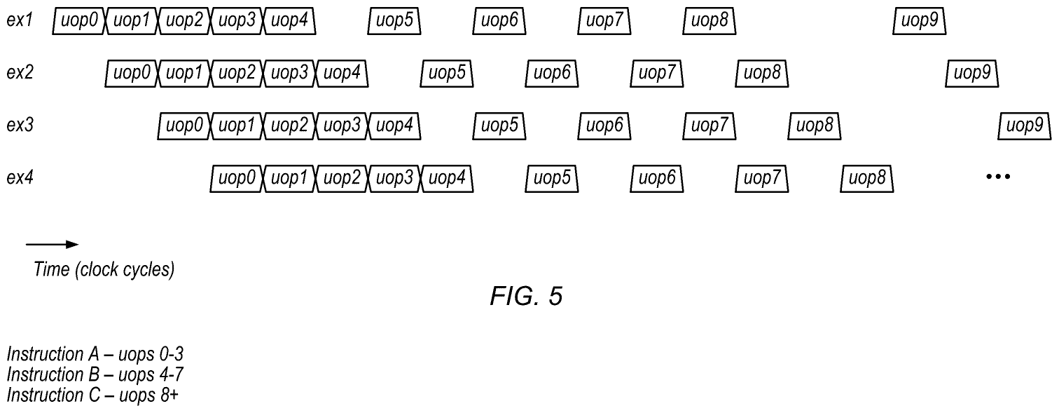

Control circuitry 210 may provide rate control to accelerator 195 at a high granularity, e.g., even switching rates between matrix multiply instructions that are consecutive in program order. Matrix multiply accelerator 195 may perform a given set of operations at the specified rate. Control circuitry 210 may utilize the known rate to determine when to access results generated by accelerator 195. Control circuitry and accelerator 195 may support a set of multiple different rates and select a rate for a given set of operations using various encodings. As non-limiting example rates, accelerator 195 may support full rate, ½ rate, ¼ rate, ⅛ rate, etc. Example pipeline states for different rates are shown in FIGS. 4-5, which are discussed in detail below.

Note that while matrix multiplication is discussed herein as an example accelerated operation, other matrix operations may be accelerated, or other operations for other multi-dimensional structures in addition to, or in place of, various disclosed operations. Further note that while control circuitry 210 of the processor circuitry 260 generates a set of operations based on a matrix multiply instruction in the illustrated example, control circuitry of accelerator 195 may generate the set of operations in other embodiments. Similarly, the control circuitry configured to control the rate for a given set of instructions may be located in various appropriate components or distributed among circuit components.

### Example Thermal-Based Control and Completion Tracking

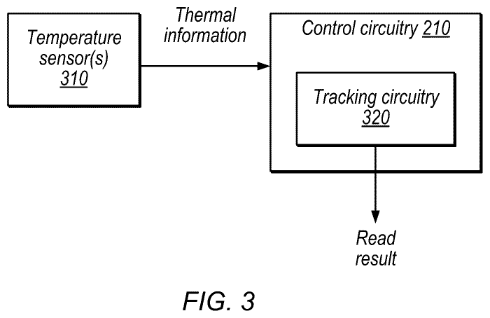

FIG. 3 is a block diagram illustrating example thermal-based rate control and rate-based completion tracking, according to some embodiments. In the illustrated example, the system includes temperature sensor(s) 310 and control circuitry 210 includes tracking circuitry 320.

Temperature sensor(s) 310, in some embodiments, are configured to measure temperature of the system at one or more locations. In some embodiments, at least one temperature is located proximate the matrix multiply accelerator 195. Non-limiting examples of types of sensors that may be implemented include negative temperature coefficient (NTC) thermistors, resistance temperature detectors (RTDs), thermocouples, and semiconductor-based sensors. In some embodiments, control circuitry 210 is configured to reduce the rate for accelerator 195 when measured temperature (or a temperature value calculated based on one or more measured temperatures) meets a threshold value. Note that “meeting” a threshold value may correspond to matching the value or passing the value in a certain direction, in different implementations. In some embodiments, control circuitry 210 implements multiple temperature thresholds and is configured to implement multiple rates for accelerator 195 depending on which threshold is met.

In some embodiments, control circuitry 210 implements a controller (e.g., a proportional-integral (PI) controller) to determine the rate for a given matrix instruction based on temperature measurements over time. In some embodiments, a threshold trigger measurement triggers operations of the PI controller and subsequent rate control decisions are progressively made based on PI controller state. Further note that different temperature measurements may be weighted differently in control decisions, e.g., based on the location of corresponding sensors in the system.

In some embodiments, control circuitry 210 is configured to consider one or more other types of inputs in addition to or in place of temperature measurements. For example, control circuitry 210 may consider supply voltage measurements, electrical current measurements, power state of components of accelerator 195 or other components of the system, etc. to determine the rate at which to operate accelerator 195 for a given ISA instruction. These other inputs may be independently compared to threshold values, utilized as additional inputs to control functions, considered as additional inputs to a PI controller, etc.

In embodiments with multiple accelerators 195, control circuitry may control different accelerators to operate at different rates for one or more matrix instructions executed at least partially in parallel by the different accelerators, e.g., based on different temperature measurements proximate the different accelerators.

Tracking circuitry 320, in some embodiments, is configured to track completion of a given set of operations (e.g., a set of micro-operations for accelerator 195 generated based on an ISA instruction) based on the rate signaled by control circuitry 210 for that set of actions. For example, tracking circuitry 320 may count a number of clock cycles that is based on the rate (e.g., a larger number for a slower rate and vice versa) to determine when to access results for the ISA instruction.

### Example Power Gating Techniques

In some embodiments, various circuitry may be power gated, clock gated, or both in conjunction with operating accelerator circuitry at a lower rate. For example, entire accelerators may be powered down in some scenarios, components within an accelerator may be power gated, pipeline stages may be clock gated during operation, etc. This may reduce overall power consumption, potentially in conjunction with thermal control.

FIG. 4 is a block diagram illustrating example power gating of accelerator hardware, according to some embodiments. In the illustrated example, the system includes one or more programmable shaders 160, one or more matrix multiply accelerators 195, power control circuitry 410, and schedule circuitry 420. In embodiments with multiple shader cores and accelerators, a set of one or more accelerators may be assigned to perform operations for a given shader core.

Power control 410, in some embodiments, is configured to power gate circuitry that is not currently being used. For example, based on thermal measurements, power control 410 may power gate one or more accelerators 195 in addition to reducing the rate of one or more accelerators 195. Further, power control 410 may clock gate various circuitry within an accelerator 195 based on its current rate.

Schedule circuitry 420, in some embodiments, is configured to send work to different programmable shaders 160 or portions thereof. For example, a given shader core may be split into multiple sub-units that may be referred to as mGPUs, each with its own work queue circuitry and shader pipeline circuitry configured to execute SIMT groups. Schedule circuitry 420 may track which accelerators 195 are power gated and refrain from sending threads that includes accelerated instructions to mGPUs serviced by those accelerators.

Further, in some embodiments, control circuitry 210 may utilize rate control to ramp up operations on a given accelerator 195, e.g., when it is first powered up (e.g., in response to detecting an instruction that targets accelerator 195 in a program executed by a shader core 160). This may be used to safely begin accelerated operations prior to reaching a full target voltage, in some embodiments.

### Example Accelerator Pipeline States at Different Rates

FIG. 5 is a pipeline state diagram for different example accelerator rates according to one de-rate implementation, according to some embodiments. The illustrated example corresponds to inserting bubbles into the accelerator pipeline to achieve a target rate.

In this example, each matrix operation utilizes four micro-operations (uops) and there are four pipeline stages. Specifically, instruction A is unrolled to uops 0-3, instruction B is unrolled to uops 4-7, and instruction C is unrolled to uops 8-12 (not all of which are shown). Various embodiments may utilize additional micro-operations (e.g., for larger matrices), additional pipeline stages, etc. The example sizing is included for purpose of illustration but not intended to limit the scope of this disclosure.

In this example, instruction A runs at full rate, instruction B runs at ½ rate, and instruction C runs at ¼ rate. As shown, consecutive uops for instruction A at full rate occupy consecutive pipeline stages (e.g., uop0 proceeds directory from ex1 to ex2, uop1 occupies ex1 immediately after uop0 has exited ex1, and so on). Therefore, in this example, the set of uops completes over eight cycles.

As shown, for instruction B at ½ rate there are idle pipeline stages between uops. For example, uop5 occupies ex3 in the cycle in which uop6 occupies ex1, leaving ex2 idle. This may correspond to insertion of a bubble at ex1 the cycle after uop5 occupies ex1.

As shown, for instruction C at ¼ rate there are multiple idle pipeline stages between uops (three in this example). Note that certain rates may result in all pipeline stages being idle in certain cycles. For example, in the illustrated example with four uops per matrix instruction and four pipeline stages, all four stages will be idle in some cycles for ⅛ rate.

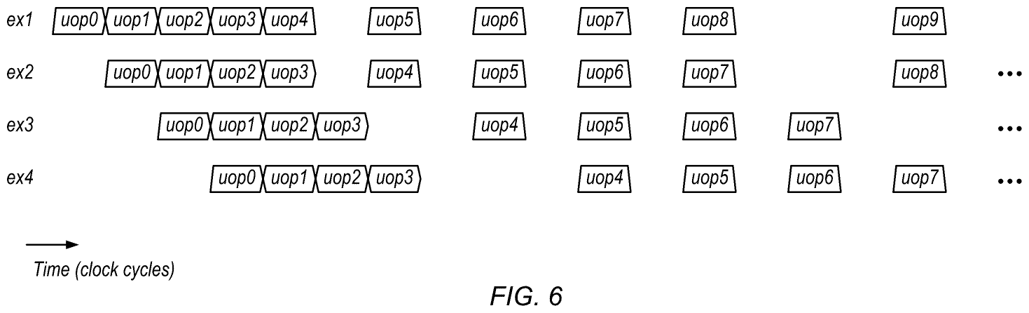

Note that according to the illustrated scheme, half of the pipeline stages are idle at a given time for instruction B and ¾ of the pipeline stages are idle at a given time for instruction C. This implementation may be advantageous for change-in-current-over-time (di/dt) considerations, relative to other implementations (e.g., relative to the implementation of FIG. 6 in which all pipeline stages may be idle in one cycle while multiple stages are active in the next cycle).

Note that in other embodiments, control circuitry may control different pipelines or ALUs to have bubbles at different times, to further reduce di/dt impacts. For example, for a given set of uops from the same matrix instruction executed at ½ rate, two ALU pipelines may alternative between receiving a new uop in a given cycle. This may add complication in writing back results, but these tradeoffs may be acceptable or desirable for some implementations, e.g., depending on multiplier topology.

FIG. 6 is a pipeline state diagram for different example accelerator rates according to a different de-rate implementation, according to some embodiments. In this example, the instructions and uops correspond to the example of FIG. 5.

In the example of FIG. 6, however, rather than bubble insertion, control circuitry performs a clock eating technique, e.g., by chopping the clock signal at the root and only advancing pipeline stages every other cycle. As shown, this reduces the execution rate on a per-ISA instruction basis but stacks the pipeline stages. For example, for uops 4-7 all pipeline stages are busy every other cycle and idle every other cycle. For uops 8+, some of the pipeline stages are busy some cycles and all pipeline stages idle in other cycles.

As discussed above, the implementation of FIG. 5 may be preferred in some embodiments, but both the implementations of FIG. 5 and FIG. 6 are contemplated, among other potential techniques for rate control of an accelerator pipeline.

### Example Method

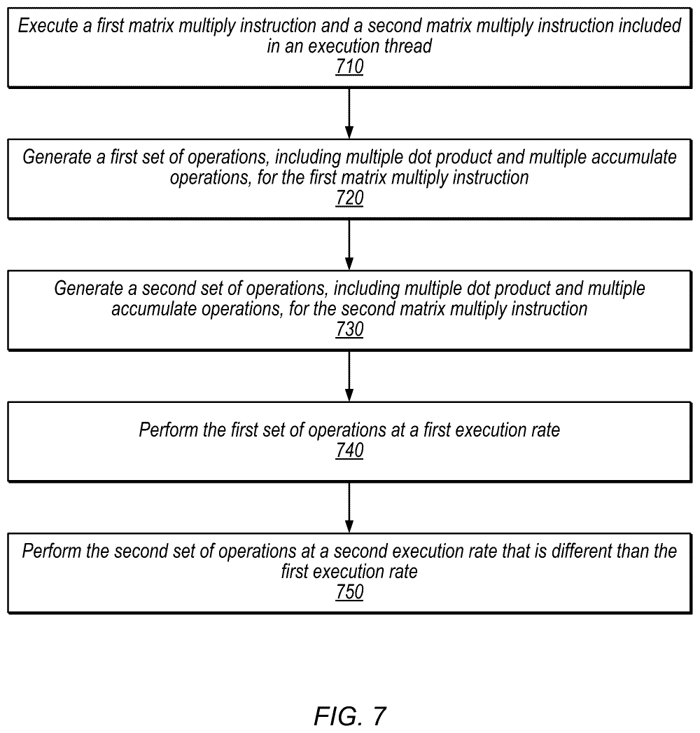

FIG. 7 is a flow diagram illustrating an example method, according to some embodiments. The method shown in FIG. 7 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 710, in the illustrated embodiment, a computing system (e.g., processor circuitry 260) executes a first matrix multiply instruction and a second matrix multiply instruction included in an execution thread.

At 720, in the illustrated embodiment, the computing system (e.g., control circuitry 210) generates a first set of operations, including multiple dot product and multiple accumulate operations, for the first matrix multiply instruction. Note that the multiple dot product and multiple accumulate operations may be specified as a set of combined dot-product-accumulate operations or may be separately specified.

At 730, in the illustrated embodiment, the computing system (e.g., control circuitry 210) generates a second set of operations, including multiple dot product and multiple accumulate operations, for the second matrix multiply instruction. Note that control circuitry that generates the first and second set of operations may be included in the requesting processor, in the accelerator hardware, or elsewhere.

At 740, in the illustrated embodiment, the computing system (e.g., matrix multiply accelerator 195) performs the first set of operations at a first execution rate.

At 750, in the illustrated embodiment, the computing system (e.g., matrix multiply accelerator 195) performs the second set of operations at a second execution rate.

In some embodiments, control circuitry is configured to select the first and second execution rates based on a temperature measurement by one or more temperature sensors. In some embodiments, the first matrix multiply instruction and the second matrix multiply instruction are consecutive in program order, with no intervening instructions.

In some embodiments, tracker circuitry is configured to track status of the first matrix multiply instruction based on the first execution rate and access results of the first matrix multiply instruction based on the tracked status.

In some embodiments (e.g., as shown in FIG. 5) the second execution rate is a non-full rate and, to perform the second set of operations at the second execution rate, the matrix acceleration circuitry is configured to impose pipeline bubbles between operations in the second set of operations such that: at least one pipeline stage in a pipeline of the matrix acceleration circuitry is active in any given cycle during execution of the second set of operations and all pipeline stages of the pipeline are not active in any given cycle during execution of the second set of operations. In other embodiments (e.g., as shown in FIG. 6), the apparatus includes power control circuitry configured to reduce clock pulses to one or more stages of an execution pipeline of the matrix acceleration circuitry based on the second execution rate.

In some embodiments, power control circuitry clock gates or power gates a portion of the matrix acceleration circuitry during a processing interval (e.g., in which the matrix acceleration circuitry operates at a non-full rate or independently of disclosed rate control techniques). The power gating may also be based on temperature measurements. In some embodiments, scheduler circuitry configured to refrain from sending matrix multiplication instructions to processor circuitry associated with the gated portion of the matrix acceleration circuitry, during the processing interval.

The concept of “execution” is broad and may refer to 1) processing of an instruction throughout an execution pipeline (e.g., through fetch, decode, execute, and retire stages) and 2) processing of an instruction at an execution unit or execution subsystem of such a pipeline (e.g., an integer execution unit or a load-store unit). The latter meaning may also be referred to as “performing” the instruction. Thus, “performing” an add instruction refers to adding two operands to produce a result, which may, in some embodiments, be accomplished by a circuit at an execute stage of a pipeline (e.g., an execution unit). Conversely, “executing” the add instruction may refer to the entirety of operations that occur throughout the pipeline as a result of the add instruction. Similarly, “performing” a “load” instruction may include retrieving a value (e.g., from a cache, memory, or stored result of another instruction) and storing the retrieved value into a register or other location.

As used herein the terms “complete” and “completion” in the context of an instruction refer to commitment of the instruction's result(s) to the architectural state of a processor or processing element. For example, completion of an add instruction includes writing the result of the add instruction to a destination register. Similarly, completion of a load instruction includes writing a value (e.g., a value retrieved from a cache or memory) to a destination register or a representation thereof.

The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

As used herein, the terms “clock” and “clock signal” refer to a periodic signal, e.g., as in a two-valued (binary) electrical signal. A clock periodically changes between “levels” of the clock such as voltage ranges of an electrical signal. For example, voltages greater than 0.7 volts may be used to represent one clock level and voltages lower than 0.3 volts may be used to represent another level in a binary configuration. As used herein, the term “clock edge” refers to a change in a clock signal from one level to another level. As used herein, the term “toggle” in the context of a clock signal refers to changing the value of the clock signal from one level to another level in a binary clock configuration. As used herein, the term clock “pulse” refers to an interval of a clock signal between consecutive edges of the clock signal (e.g., an interval between a rising edge and a falling edge or an interval between a falling edge and a rising edge). Note that sequential circuitry may perform operations on a rising edge of a clock signal, a falling edge of a clock signal, or both (which may be referred to as dual-edge triggered).

### Example Device

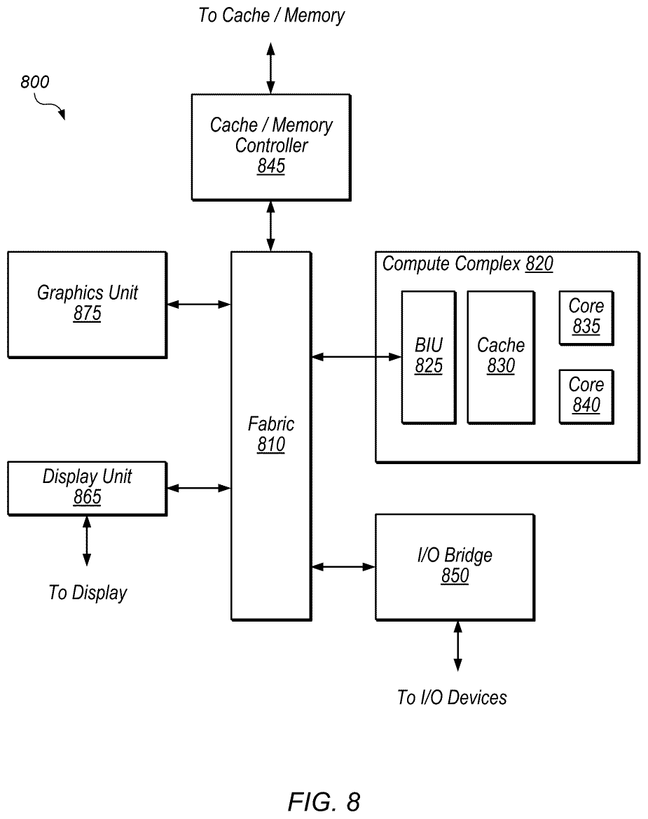

Referring now to FIG. 8, a block diagram illustrating an example embodiment of a device 800 is shown. In some embodiments, elements of device 800 may be included within a system on a chip. In some embodiments, device 800 may be included in a mobile device, which may be battery-powered. Therefore, power consumption by device 800 may be an important design consideration. In the illustrated embodiment, device 800 includes fabric 810, compute complex 820 input/output (I/O) bridge 850, cache/memory controller 845, graphics unit 875, and display unit 865. In some embodiments, device 800 may include other components (not shown) in addition to or in place of the illustrated components, such as video processor encoders and decoders, image processing or recognition elements, computer vision elements, etc.

Fabric 810 may include various interconnects, buses, MUX's, controllers, etc., and may be configured to facilitate communication between various elements of device 800. In some embodiments, portions of fabric 810 may be configured to implement various different communication protocols. In other embodiments, fabric 810 may implement a single communication protocol and elements coupled to fabric 810 may convert from the single communication protocol to other communication protocols internally.

In the illustrated embodiment, compute complex 820 includes bus interface unit (BIU) 825, cache 830, and cores 835 and 840. In various embodiments, compute complex 820 may include various numbers of processors, processor cores and caches. For example, compute complex 820 may include 1, 2, or 4 processor cores, or any other suitable number. In one embodiment, cache 830 is a set associative L2 cache. In some embodiments, cores 835 and 840 may include internal instruction and data caches. In some embodiments, a coherency unit (not shown) in fabric 810, cache 830, or elsewhere in device 800 may be configured to maintain coherency between various caches of device 800. BIU 825 may be configured to manage communication between compute complex 820 and other elements of device 800. Processor cores such as cores 835 and 840 may be configured to execute instructions of a particular instruction set architecture (ISA) which may include operating system instructions and user application instructions. These instructions may be stored in computer readable medium such as a memory coupled to memory controller 845 discussed below.

In some embodiments, compute complex 820 is configured to implement various disclosed rate control techniques, e.g., for matrix acceleration hardware or for other co-processor circuitry.

As used herein, the term “coupled to” may indicate one or more connections between elements, and a coupling may include intervening elements. For example, in FIG. 8, graphics unit 875 may be described as “coupled to” a memory through fabric 810 and cache/memory controller 845. In contrast, in the illustrated embodiment of FIG. 8, graphics unit 875 is “directly coupled” to fabric 810 because there are no intervening elements.

Cache/memory controller 845 may be configured to manage transfer of data between fabric 810 and one or more caches and memories. For example, cache/memory controller 845 may be coupled to an L3 cache, which may in turn be coupled to a system memory. In other embodiments, cache/memory controller 845 may be directly coupled to a memory. In some embodiments, cache/memory controller 845 may include one or more internal caches. Memory coupled to controller 845 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 845 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 820 to cause the computing device to perform functionality described herein.

Graphics unit 875 may include one or more processors, e.g., one or more graphics processing units (GPUs). Graphics unit 875 may receive graphics-oriented instructions, such as OPENGL®, Metal®, or DIRECT3D® instructions, for example. Graphics unit 875 may execute specialized GPU instructions or perform other operations based on the received graphics-oriented instructions. Graphics unit 875 may generally be configured to process large blocks of data in parallel and may build images in a frame buffer for output to a display, which may be included in the device or may be a separate device. Graphics unit 875 may include transform, lighting, triangle, and rendering engines in one or more graphics processing pipelines. Graphics unit 875 may output pixel information for display images. Graphics unit 875, in various embodiments, may include programmable shader circuitry which may include highly parallel execution cores configured to execute graphics programs, which may include pixel tasks, vertex tasks, and compute tasks (which may or may not be graphics-related).

In some embodiments, graphics unit 875 is configured to implement various disclosed rate control techniques, e.g., for matrix acceleration hardware or for other co-processor circuitry.

Display unit 865 may be configured to read data from a frame buffer and provide a stream of pixel values for display. Display unit 865 may be configured as a display pipeline in some embodiments. Additionally, display unit 865 may be configured to blend multiple frames to produce an output frame. Further, display unit 865 may include one or more interfaces (e.g., MIPI® or embedded display port (eDP)) for coupling to a user display (e.g., a touchscreen or an external display).

I/O bridge 850 may include various elements configured to implement: universal serial bus (USB) communications, security, audio, and low-power always-on functionality, for example. I/O bridge 850 may also include interfaces such as pulse-width modulation (PWM), general-purpose input/output (GPIO), serial peripheral interface (SPI), and inter-integrated circuit (I2C), for example. Various types of peripherals and devices may be coupled to device 800 via I/O bridge 850.

In some embodiments, device 800 includes network interface circuitry (not explicitly shown), which may be connected to fabric 810 or I/O bridge 850. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 800 with connectivity to various types of other devices and networks.

### Example Applications

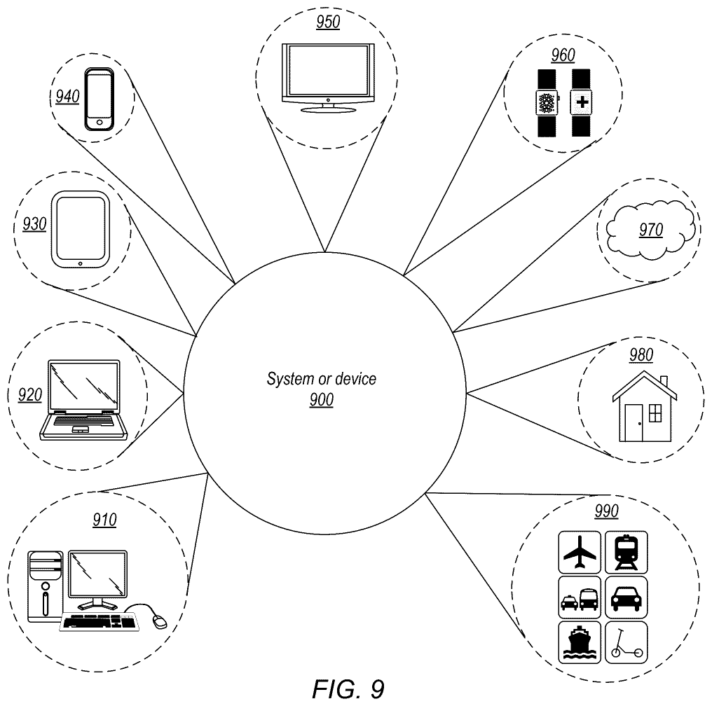

Turning now to FIG. 9, various types of systems that may include any of the circuits, devices, or system discussed above. System or device 900, which may incorporate or otherwise utilize one or more of the techniques described herein, may be utilized in a wide range of areas. For example, system or device 900 may be utilized as part of the hardware of systems such as a desktop computer 910, laptop computer 920, tablet computer 930, cellular or mobile phone 940, or television 950 (or set-top box coupled to a television).

Similarly, disclosed elements may be utilized in a wearable device 960, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 900 may also be used in various other contexts. For example, system or device 900 may be utilized in the context of a server computer system, such as a dedicated server or on shared hardware that implements a cloud-based service 970. Still further, system or device 900 may be implemented in a wide range of specialized everyday devices, including devices 980 commonly found in the home such as refrigerators, thermostats, security cameras, etc. The interconnection of such devices is often referred to as the “Internet of Things” (IoT). Elements may also be implemented in various modes of transportation. For example, system or device 900 could be employed in the control systems, guidance systems, entertainment systems, etc. of various types of vehicles 990.

The applications illustrated in FIG. 9 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

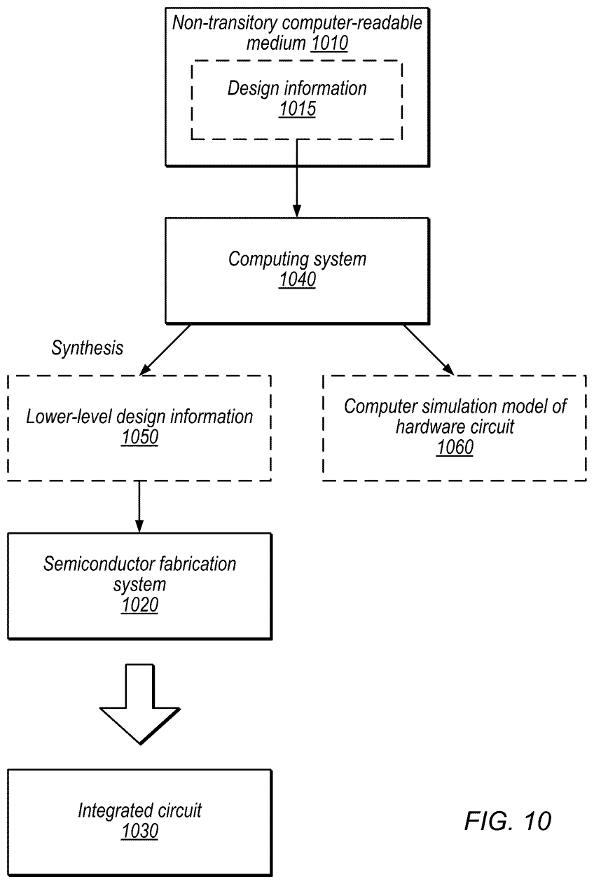

FIG. 10 is a block diagram illustrating an example non-transitory computer-readable storage medium that stores circuit design information, according to some embodiments. In the illustrated embodiment, computing system 1040 is configured to process the design information. This may include executing instructions included in the design information, interpreting instructions included in the design information, compiling, transforming, or otherwise updating the design information, etc. Therefore, the design information controls computing system 1040 (e.g., by programming computing system 1040) to perform various operations discussed below, in some embodiments.

In the illustrated example, computing system 1040 processes the design information to generate both a computer simulation model of a hardware circuit 1060 and lower-level design information 1050. In other embodiments, computing system 1040 may generate only one of these outputs, may generate other outputs based on the design information, or both. Regarding the computing simulation, computing system 1040 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1040 also processes the design information to generate lower-level design information 1050 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1050 (potentially among other inputs), semiconductor fabrication system 1020 is configured to fabricate an integrated circuit 1030 (which may correspond to functionality of the simulation model 1060). Note that computing system 1040 may generate different simulation models based on design information at various levels of description, including information 1050, 1015, and so on. The data representing design information 1050 and model 1060 may be stored on medium 1010 or on one or more other media.

In some embodiments, the lower-level design information 1050 controls (e.g., programs) the semiconductor fabrication system 1020 to fabricate the integrated circuit 1030. Thus, when processed by the fabrication system, the design information may program the fabrication system to fabricate a circuit that includes various circuitry disclosed herein.

Non-transitory computer-readable storage medium 1010, may comprise any of various appropriate types of memory devices or storage devices. Non-transitory computer-readable storage medium 1010 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1010 may include other types of non-transitory memory as well or combinations thereof. Accordingly, non-transitory computer-readable storage medium 1010 may include two or more memory media; such media may reside in different locations—for example, in different computer systems that are connected over a network.

Design information 1015 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 1040, semiconductor fabrication system 1020, or both. In some embodiments, design information may also include one or more cell libraries that specify the synthesis, layout, or both of integrated circuit 1030. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1030 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1020 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1020 may also be configured to perform various testing of fabricated circuits for correct operation.

In various embodiments, integrated circuit 1030 and model 1060 are configured to operate according to a circuit design specified by design information 1015, which may include performing any of the functionality described herein. For example, integrated circuit 1030 may include any of various elements shown in FIGS. 1B-4 and 8. Further, integrated circuit 1030 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1020 to fabricate integrated circuit 1030.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as Cor C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112 (f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
processor circuitry configured to execute a first matrix multiply instruction and a second matrix multiply instruction included in an execution thread;
control circuitry configured to:
generate:
a first set of operations, including multiple dot product and multiple accumulate operations, for the first matrix multiply instruction; and
a second set of operations, including multiple dot product and multiple accumulate operations, for the second matrix multiply instruction; and
specify a first execution rate for the first set of operations and a second, different execution rate for the second set of operations;
matrix acceleration circuitry configured to:
perform the first set of operations at the first execution rate; and
perform the second set of operations at the second execution rate.

2. The apparatus of claim 1, further comprising:
one or more temperature sensors, wherein the control circuitry is configured to select the second execution rate based on a temperature measurement by the one or more temperature sensors.

3. The apparatus of claim 1, wherein the first matrix multiply instruction and the second matrix multiply instruction are consecutive in program order, with no intervening instructions.

4. The apparatus of claim 1, wherein the first execution rate is a full rate and the second execution rate is a fraction of the full rate.

5. The apparatus of claim 1, wherein the processor circuitry includes tracker circuitry configured to:
track status of the first matrix multiply instruction based on the first execution rate; and
access results of the first matrix multiply instruction based on the tracked status.

6. The apparatus of claim 1, wherein:
the second execution rate is a non-full rate; and
to perform the second set of operations at the second execution rate, the matrix acceleration circuitry is configured to impose pipeline bubbles between operations in the second set of operations such that:
at least one pipeline stage in a pipeline of the matrix acceleration circuitry is active in any given cycle during execution of the second set of operations; and
all pipeline stages of the pipeline are not active in any given cycle during execution of the second set of operations.

7. The apparatus of claim 1, further comprising:
power control circuitry configured to clock gate or power gate a portion of the matrix acceleration circuitry during a processing interval.

8. The apparatus of claim 7, further comprising:
scheduler circuitry configured to refrain from sending matrix multiplication instructions to processor circuitry associated with the gated portion of the matrix acceleration circuitry, during the processing interval.

9. The apparatus of claim 1, wherein:
the second execution rate is a non-full rate; and
the apparatus includes power control circuitry configured to reduce clock pulses to one or more stages of an execution pipeline of the matrix acceleration circuitry based on the second execution rate.

10. The apparatus of claim 1, wherein the processor circuitry is shader processor circuitry of a graphics processor.

11. The apparatus of claim 1, wherein the apparatus is a computing device that further includes:
a display; and
network interface circuitry.

12. A method, comprising:
executing, by a processor of a computing device, a first matrix multiply instruction and a second matrix multiply instruction included in an execution thread;
generating, by the computing device, a first set of operations, including multiple dot product and multiple accumulate operations, for the first matrix multiply instruction;
generating, by the computing device, a second set of operations, including multiple dot product and multiple accumulate operations, for the second matrix multiply instruction;
performing, by matrix acceleration hardware of the computing device, the first set of operations at a first execution rate; and
performing, by the matrix acceleration hardware, the second set of operations at a second, different execution rate.

13. The method of claim 12, further comprising:
selecting, by the computing device, the first execution rate and the second execution rate based on a temperature measurement by a temperature sensor.

14. The method of claim 12, wherein the first matrix multiply instruction and the second matrix multiply instruction are consecutive in program order, with no intervening instructions.

15. The method of claim 12, wherein the first execution rate is a full rate and the second execution rate is a fraction of the full rate.

16. The method of claim 12, further comprising:
tracking, by the processor, status of the first matrix multiply instruction based on the first execution rate; and
accessing, by the processor, results of the first matrix multiply instruction based on the tracked status.

17. The method of claim 12, wherein:
the second execution rate is a non-full rate; and
performing the second set of operations includes imposing pipeline bubbles between operations in the second set of operations such that:
at least one pipeline stage in a pipeline of the matrix acceleration hardware is active in any given cycle during execution of the second set of operations; and
all pipeline stages of the pipeline are not active in any given cycle during execution of the second set of operations.

18. The method of claim 12, further comprising:
clock gating a portion of the matrix acceleration hardware during a processing interval.

19. A non-transitory computer-readable medium having instructions of a hardware description programming language stored thereon that, when processed by a computing system, program the computing system to generate a computer simulation model, wherein the model represents a hardware circuit that includes:
processor circuitry configured to execute a first matrix multiply instruction and a second matrix multiply instruction included in an execution thread;
control circuitry configured to:
generate:
a first set of operations, including multiple dot product and multiple accumulate operations, for the first matrix multiply instruction; and
a second set of operations, including multiple dot product and multiple accumulate operations, for the second matrix multiply instruction; and
specify a first execution rate for the first set of operations and a second, different execution rate for the second set of operations;
matrix acceleration circuitry configured to:
perform the first set of operations at the first execution rate; and
perform the second set of operations at the second execution rate.

20. The non-transitory computer-readable medium of claim 19, wherein the circuit further includes:
one or more temperature sensors, wherein the control circuitry is configured to select the second execution rate based on a temperature measurement by the one or more temperature sensors.
